(19) United States
(12) Patent Application Publication
(10) Pub. No.: US 2025/0045092 A1
(43) Pub. Date: Feb. 6, 2025

(54) CONTINUOUS INTEGRATION SYSTEM MONITORING FOR DEPENDENCIES ON REMOTE SYSTEMS

(71) Applicant: Red Hat, Inc., Raleigh, NC (US)

(72) Inventors: Leigh Griffin, Waterford (IE); Laura Barcziova, Brno (CZ)

(21) Appl. No.: 18/362,206

(22) Filed: Jul. 31, 2023

(51) Int. Cl. G06F 9/48

(52) U.S. Cl. CPC G06F 9/4831

(57) ABSTRACT

A computing device executes a job from among a plurality of jobs executed by a continuous integration system, the job initiating a task from among a plurality of tasks for the job and the task invoking a first remote system. The computing device determines, based on a notification associated with the first remote system, that the task failed in response to invoking the first remote system. The computing device identifies a first job from among the plurality of jobs, the first job having at least one task that invokes the first remote system. The computing device performs an action based on a priority of the first job.

### BACKGROUND

A continuous integration system, such as a continuous integration and continuous delivery (CI/CD) pipeline, runs jobs that include tasks or steps to perform for a successful software integration, delivery, or deployment to an environment. The continuous integration system may communicate with and depend on remote services for a successful run.

### SUMMARY

The examples disclosed herein implement a continuous integration (CI) system monitor that performs continuous integration system monitoring for dependencies on remote systems. In particular, the CI system monitor can monitor jobs and tasks in a CI/CD pipeline of the CI system where the jobs and the tasks depend on a remote system. A task may invoke a remote system, and the CI system monitor can determine that the task failed and that the remote system is unavailable. In response, the CI system monitor can pause other jobs and tasks that depend on the remote system and perform an action to minimize downtime in the CI/CD pipeline and conserve resources when the remote system is unavailable.

In one example, a method for continuous integration system monitoring for dependencies on remote systems is provided. The method includes executing, by a continuous integration (CI) system, a job from among a plurality of jobs executed by the CI system, the job initiating a task from among a plurality of tasks for the job and the task invoking a first remote system. The method further includes determining, by the CI system based on a notification associated with the first remote system, that the task failed in response to invoking the first remote system. The method further includes identifying, by the CI system, a first job from among the plurality of jobs, the first job having at least one task that invokes the first remote system. The method further includes performing, by the CI system, an action based on a priority of the first job.

In another example, a computing device for continuous integration system monitoring for dependencies on remote systems is provided. The computing device includes a memory and a processor device coupled to the memory. The processor device is to execute a job from among a plurality of jobs executed by a continuous integration system, the job initiating a task from among a plurality of tasks for the job and the task invoking a first remote system. The processor device is further to determine, based on a notification associated with the first remote system, that the task failed in response to invoking the first remote system. The processor device is further to identify a first job from among the plurality of jobs, the first job having at least one task that invokes the first remote system. The processor device is further to perform an action based on a priority of the first job.

In another example, a non-transitory computer-readable storage medium for continuous integration system monitoring for dependencies on remote systems is provided. The non-transitory computer-readable storage medium includes computer-executable instructions to cause a processor device to execute a job from among a plurality of jobs executed by a continuous integration system, the job initiating a task from among a plurality of tasks for the job and the task invoking a first remote system. The instructions further cause the processor device to determine, based on a notification associated with the first remote system, that the task failed in response to invoking the first remote system. The instructions further cause the processor device to identify a first job from among the plurality of jobs, the first job having at least one task that invokes the first remote system. The instructions further cause the processor device to perform an action based on a priority of the first job.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing device in which examples of continuous integration system monitoring for dependencies on remote systems may be practiced;

FIG. 2 is a flowchart illustrating operations performed by the computing device of FIG. 1 for continuous integration system monitoring for dependencies on remote systems, according to one example;

FIG. 3 is a block diagram of the computing device of FIG. 1 for continuous integration system monitoring for dependencies on remote systems, according to one example;

FIG. 4 is a block diagram of the computing device of FIG. 1 for continuous integration system monitoring for dependencies on remote systems, according to one example;

FIG. 5 is a block diagram of the computing device of FIG. 1 for continuous integration system monitoring for dependencies on remote systems, according to one example;

FIG. 6 is a flowchart illustrating operations performed by the computing device of FIG. 1 for continuous integration system monitoring for dependencies on remote systems, according to one example;

FIG. 7 is a block diagram of the computing device of FIG. 1 for continuous integration system monitoring for dependencies on remote systems, according to one example; and

FIG. 8 is a block diagram of a computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the elements unless otherwise explicitly specified. The word “or” as used herein and in the claims is inclusive unless contextually impossible. As an example, the recitation of A or B means A, or B, or both A and B. The word “data” may be used herein in the singular or plural depending on the context.

A continuous integration system, such as a continuous integration and continuous delivery (CI/CD) pipeline, runs jobs that include tasks or steps to perform for a successful software integration, delivery, or deployment to an environment. The continuous integration system may communicate with and depend on remote services for a successful run. As a result, when a remote service is unavailable, the jobs and tasks of the CI/CD pipeline can fail, causing a build-up of jobs and tasks in a queue and downtime for the CI/CD pipeline.

The examples disclosed herein implement a continuous integration (CI) system monitor that performs continuous integration system monitoring for dependencies on remote systems. The CI system monitor can monitor jobs and tasks in a CI/CD pipeline of the CI system where the jobs and the tasks depend on a remote system, such as a remote service. A task may invoke a remote system and the CI system monitor can determine that the task failed due to an unavailability of the remote system. In response, the CI system monitor can pause other jobs and tasks that depend on the remote system and perform an action to minimize downtime in the CI/CD pipeline when the remote system is unavailable.

Continuous integration (CI) is the process of integrating code changes from multiple developers into a main branch of a shared central source code repository and automatically building and testing the changes upon commit or merge of the code changes into the main branch. Continuous delivery (CD) is the process of automatically building, testing, and preparing the code changes from the CI process for release to production by a developer at any time, such as packaging the code with resources needed to deploy to any environment and provisioning the infrastructure. Continuous deployment refers to automatically deploying the changes in the source code to production. A CI/CD pipeline is a series of tasks or steps to be automatically performed in sequence or in parallel in the CI/CD process, such as compiling code, testing code, code analysis, security steps, and packaging code into a container image upon a change in code in the source code repository. The steps of the CI/CD pipeline may be implemented by a CI/CD system, such as Jenkins, GitLab, Bamboo, or OpenShift Pipelines, as non-limiting examples. In a CI system, a CI/CD pipeline can include jobs that define a portion of the CI/CD process, such as compiling or packaging code, and jobs can include tasks for executing the job, such as running scripts and pulling container images.

When a task fails due to an unavailability of a remote system that the task depends on, the CI system monitor can determine the priority of the task or the job that is running the task and use the priority to determine an action to take. When the priority of the job or task is high, the CI system monitor may find another remote system from another remote location that is available and modify the task and job to use the other remote system, or find a local version of the remote system and modify the task and job to use the local version. The CI system monitor can also ping the other remote service, such as by sending a request, to ensure that the other remote system is available for the modified task or job to use. When the priority of the job or task is low, the CI system monitor may pause the jobs and tasks for an amount of time and ping the remote system to determine whether the remote system has come back online and is available for use. The CI system monitor may receive a response from the remote system that indicates that the remote system is available and resume the jobs and the tasks. The CI system may alternatively receive no response or a response that indicates that the remote system is unavailable and continue to wait an amount of time and ping the remote system until the remote system is unavailable and the jobs and tasks can be resumed.

When a remote system comes back online and multiple jobs and tasks depend on the remote system, the CI system monitor may resume the jobs and tasks that depend on the remote system in a cascading manner. For instance, higher priority jobs and tasks may be resumed first, and lower priority jobs and tasks may be resumed after waiting for a period of time. As a result, the remote system can handle requests from the jobs and tasks in smaller increments instead of being overwhelmed with requests from all of the jobs and tasks that depend on the remote system at the same time.

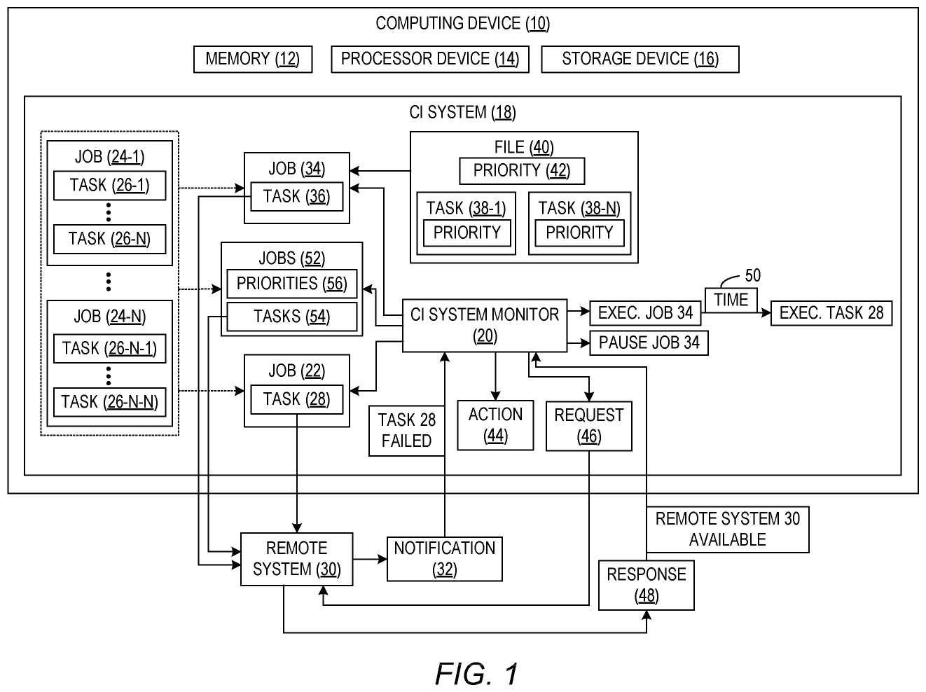

FIG. 1 is a block diagram of a computing device 10 that comprises a system memory 12, a processor device 14, and a storage device 16 in which examples of continuous integration system monitoring for dependencies on remote systems may be practiced. It is to be understood that the computing device 10 in some examples may include constituent elements in addition to those illustrated in FIG. 1. In the example of FIG. 1, the computing device 10 includes a continuous integration (CI) system 18 and the CI system 18 implements a continuous integration (CI) system monitor 20 that performs continuous integration system monitoring for dependencies on remote systems. It is to be understood that the computing device 10 in some examples may include constituent elements in addition to those illustrated in FIG. 1.

The CI system 18 may be any CI/CD system, such as Jenkins, GitLab, Bamboo, and OpenShift Pipelines, as non-limiting examples. The CI system monitor 20 may execute a job 22 from among a plurality of jobs 24-1-24-N (collectively, jobs 24) in a queue. Each job of the jobs 24 may initiate one or more tasks from among a plurality of tasks for the respective job. For instance, a job 24-1 may include a plurality of tasks 26-1-26-N to be initiated in sequence or in parallel when the job 24-1 is executed. The job 22 may initiate a task 28 from among a plurality of tasks for the job 22. The task 28 may invoke a first remote system 30 that is external to the CI system 18 and the computing device 10. For instance, the first remote system 30 may be a remote repository of files or container images, an edge device, or a cloud computing device with resources for the task 28 to use, such as a task that downloads a file from a remote repository, as non-limiting examples. Because the task 28 invokes the first remote system 30, the task 28 is said to depend on the first remote system 30, so if the first remote system 30 is unavailable, then the task 28 cannot be completed and the job 22 that initiated the task 28 cannot be completed, resulting in a failed CI/CD pipeline run. The dependency of the task 28 on the first remote system 30 may be determined by obtaining a specification file for the CI system 18 that identifies the jobs, the tasks, and the steps of the tasks of the CI system 18, such as the remote systems (e.g., the first remote system 30) to invoke when the task runs, as a non-limiting example.

After the task 28 invokes the first remote system 30, the CI system monitor 20 may determine that the task 28 failed based on a notification 32. The notification 32 may be a message, a warning, an event, a status code, an error code, or logs for the task 28, as non-limiting examples, that identifies the failure that occurred when the task 28 invoked the first remote system 30. The CI system monitor 20 may determine that the task 28 failed when the CI system monitor 20 receives the notification 32 from the first remote system 30 after invoking the first remote system 30. The task 28 failure can indicate that the first remote system 30 is unavailable, such as being out of network, out of range, or having a power or capacity issue, and that the first remote system 30 cannot be accessed by a task or a job that is invoking the first remote system 30. As a result, the task 28 that depends on the first remote system 30 cannot be performed.

The CI system monitor 20 can identify a first job 34 from among the jobs 24 that has at least one task 36 that invokes the first remote system 30 (i.e., the at least one task 36 depends on the first remote system 30). In some implementations, the CI system monitor 20 may identify the first job 34 by obtaining a file 40 that defines the first job 34. For instance, the file 40 may include a plurality of tasks 38-1-38-N (collectively, tasks 38) for the first job 34 to initiate (e.g., the task 36) and the steps of the tasks 38, such as the remote systems (e.g., the first remote system 30) to invoke when the task runs, a priority 42 of the first job 34, and a priority of each of the tasks 38. The priority 42 of the first job 34, as well as the priority of each of the tasks 38, may be a level, such as low, medium, high, or critical, that can be set by a user when creating the job or the task. For instance, a job or a task with a high priority may require more measures be taken to ensure the job or the task executes successfully without delay, while a job or a task with a low priority may be able to have some downtime without impacting the job or the task. In some implementations, the CI system monitor 20 may identify the first job 34 by accessing a file or other component that identifies the remote systems and the jobs and tasks that depend on the remote systems, and determining, based on the file or component, that the first job 34 has the at least one task 36 that invokes the first remote system 30.

Based on the file 40, the CI system monitor 20 may determine that the first job 34 has the at least one task 36 that invokes the first remote system 30. In some examples, the CI system monitor 20 may obtain the file 40 for the first job 34 and parse the file 40 to determine the tasks 38 for the first job 34 and the remote systems that the tasks 38 invoke (e.g., the first remote system 30). Upon parsing the file 40, the CI system monitor 20 may determine that the at least one task 36 of the first job 34 invokes the first remote system 30.

After determining that the first job 34 has the at least one task 36 that invokes the first remote system 30, the CI system monitor 20 may pause the first job 34. The first job 34 can be paused in order to stop the first job 34 and the tasks of the first job 34 (e.g., the task 36) from attempting to access the first remote system 30 that is unavailable. The task 28 and/or the job 22 may also be paused in order to stop further execution of the task 28 and/or the job 22 while the first remote system 30 is unavailable. Pausing the task 28, the job 22, and the first job 34 can provide for waste management by conserving CPU and memory resources when the task 28, the job 22, and the first job 34 will fail due to the unavailability of the first remote system 30.

The CI system monitor 20 may perform an action 44 based on the priority 42 of the first job 34. The CI system monitor 20 may determine the priority 42 of the first job 34 by obtaining the file 40 that defines the first job 34, which includes the priority 42 of the first job 34. In some examples, the CI system monitor 20 may obtain the file 40 for the first job 34 and parse the file 40 to determine the priority 42 of the first job 34. In some implementations, the CI system monitor 20 may determine a plurality of tasks 38 of the first job 34 and a priority of each task of the plurality of tasks 38, such as by parsing the file 40 to identify the tasks 38 and the priority level that is set for each task. The CI system monitor 20 may determine which of the priorities of the tasks 38 are the highest and the priority 42 of the first job 34 may be set to be the same as the highest priority task of the tasks 38.

After performing the action 44, the CI system monitor 20 may send a request 46 to the first remote system 30. The request 46 may be sent by the CI system monitor 20 to determine whether the first remote system 30 is available or unavailable. The first remote system 30 may send a response 48 to the CI system monitor 20 that indicates that the first remote system 30 is available. The CI system monitor 20 may receive the response 48 and modify the task 28 to use the first remote system 30 since the first remote system 30 is no longer unavailable and the task 28 and the job 22 can resume to invoke the first remote system 30. The CI system monitor 20 may also modify the first job 34 that has the at least one task 36 that invokes the first remote system 30 to use the first remote system 30 since the first remote system 30 is no longer unavailable and the task 36 can resume to invoke the first remote system 30.

The CI system monitor 20 may determine that the at least one task 36 of the first job 34 is a final task of a plurality of tasks for the first job 34. For instance, the CI system monitor 20 may parse the file 40 for the first job 34 to determine the order of the plurality of tasks to be performed in the first job 34 and identify the task that is to be performed last. The CI system monitor 20 may similarly determine that the task 28 is a first task of the plurality of tasks of the job 22. Since the at least one task 36 of the first job 34 is the final task for the first job 34 (i.e., the first job 34 is almost complete), the CI system monitor 20 may first modify the first job 34 to use the first remote system 30 and execute the first job 34 with the task 36 that invokes the first remote system 30. The CI system monitor 20 may wait a predetermined amount of time 50 (e.g., 10-20 seconds). The CI system monitor 20 may then modify the task 28 to use the first remote system 30 and execute the task 28, which invokes the first remote system 30, since the task 28 is the first task for the job 22 (i.e., the job 22 has just started). Waiting for a period of time can allow for the first remote system 30 to begin receiving requests (e.g., from the task 36 and the task 28) for the services of the first remote system 30 in a cascading manner so that the first remote system 30 does not immediately receive an overwhelming number of requests once the first remote system 30 is available, which could cause the first remote system 30 to again become unavailable.

In some implementations, the CI system monitor 20 may determine that the task 28 failed and identify a subset of jobs 52 from among the plurality of jobs 24, each job of the subset of jobs 52 having at least one task that invokes the first remote system 30. For instance, tasks 54 may be the tasks of the subset of jobs 52 that invoke the first remote system 30. The CI system monitor 20 may identify the subset of jobs 52 and the tasks 54 of the subset of jobs 52 that invoke the first remote system 30 by obtaining files that define each job of the plurality of jobs 24 and parsing each file to determine the tasks of each job and whether each task invokes the first remote system 30, the priority of each job, and the priority of each task of the tasks of each job. The CI system monitor 20 may pause the subset of jobs 52 in order to stop further execution of the subset of jobs 52 and/or the tasks 54 of the subset of jobs 52 while the first remote system 30 is unavailable. The CI system monitor 20 can perform an action (e.g., the action 44) for each job of the subset of jobs 52 based on a priority of each job of the subset of jobs 52. For instance, priorities 56 may be the priority of each job of the subset of jobs 52, which may have been obtained by the CI system monitor 20 parsing the files that define each job of the subset of jobs 52. The priorities 56 may each be a level, such as low, medium, high, or critical, that can be set by a user when creating the jobs (e.g., the subset of jobs 52) or the tasks of the jobs (e.g., the tasks 54). In some examples, the priorities 56 may include the priority of each job of the subset of jobs 52 and the priority of each job may be the same as the priority of the highest priority task of the tasks for the respective job.

The CI system monitor 20 may send a request to the first remote system 30 and receive a response from the first remote system 30, and determine that the first remote system 30 is available as a result of receiving the response. The CI system monitor 20 may modify the tasks 54 to use the first remote system 30 since the first remote system 30 is no longer unavailable and the tasks 54 and the subset of jobs 52 can resume to invoke the first remote system 30. The CI system monitor 20 may execute each task of the tasks 54 that invoke the first remote system 30 in a cascading manner by starting a task, waiting a predetermined period of time, then starting a next task until all of the tasks 54 are run so that the first remote system 30 does not immediately receive an overwhelming number of requests once the first remote system 30 is available, which could cause the first remote system 30 to again become unavailable. In some implementations, the tasks 54 may be started in a cascading manner based on the order of the tasks for each job of the subset of jobs 52 by starting the tasks that are the final tasks for the respective job before starting the tasks that are the first tasks for the respective job. In other implementations, the tasks 54 may be started in a cascading manner based on the priority of the tasks and/or the priorities 56 of the jobs of the subset of jobs 52 by starting the tasks and/or the jobs that are high priority before starting the jobs and/or the tasks that are low priority.

It is to be understood that, because the CI system monitor 20 is a component of the computing device 10, functionality implemented by the CI system monitor 20 may be attributed to the computing device 10 generally. Moreover, in examples where the CI system monitor 20 comprises software instructions that program the processor device 14 to carry out functionality discussed herein, functionality implemented by the CI system monitor 20 may be attributed herein to the processor device 14. It is to be further understood that while, for purposes of illustration only, the CI system monitor 20 is depicted as a single component, the functionality implemented by the CI system monitor 20 may be implemented in any number of components, and the examples discussed herein are not limited to any particular number of components.

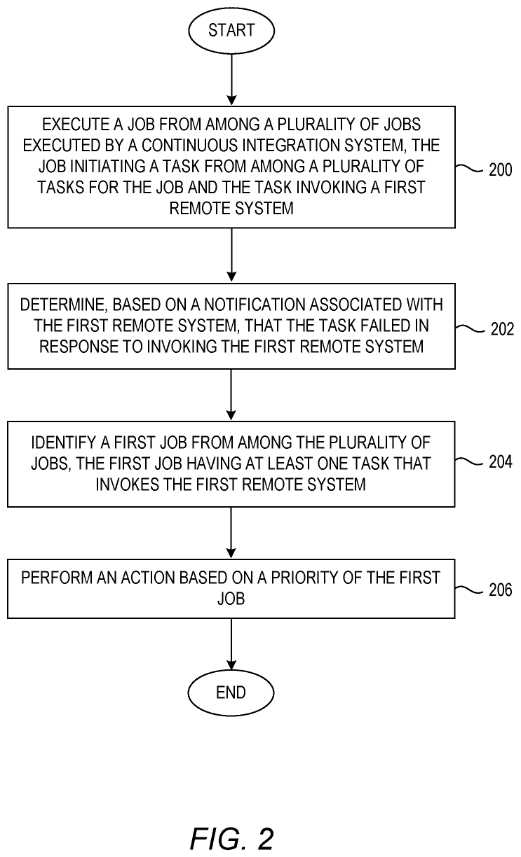

FIG. 2 is a flowchart illustrating operations performed by the computing device of FIG. 1 for continuous integration system monitoring for dependencies on remote systems, according to one example. Elements of FIG. 1 are referenced in describing FIG. 2 for the sake of clarity. In FIG. 2, operations begin with a processor device of a computing device, such as the processor device 14 of the computing device 10 of FIG. 1, the processor device 14 to execute a job from among a plurality of jobs executed by a continuous integration system, the job initiating a task from among a plurality of tasks for the job and the task invoking a first remote system (block 200). The processor device 14 is further to determine, based on a notification associated with the first remote system, that the task failed in response to invoking the first remote system (block 202). The processor device 14 is further to identify a first job from among the plurality of jobs, the first job having at least one task that invokes the first remote system (block 204). The processor device 14 is further to perform an action based on a priority of the first job (block 206).

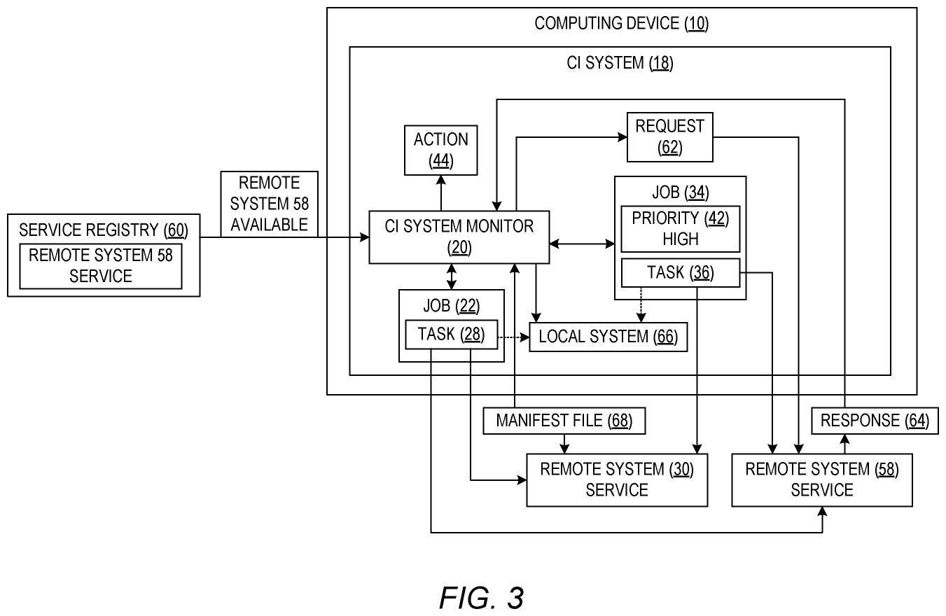

FIG. 3 is a block diagram of the computing device of FIG. 1 for continuous integration system monitoring for dependencies on remote systems, according to one example. Elements of FIG. 1 are referenced in describing FIG. 3 for the sake of clarity. In the example of FIG. 3, the CI system monitor 20 may perform the action 44 based on the priority 42 of the first job 34 by determining that the priority 42 of the first job 34 is a high priority. The CI system monitor 20 may determine that the priority 42 of the first job 34 is a high priority by obtaining the file 40 that defines the first job 34 and parsing the file 40 to determine that the priority 42 of the first job 34 is a high priority. Because the priority 42 of the first job 34 is a high priority, the CI system monitor 20 can determine whether there is an alternate version of the first remote system 30 that is available in order to reduce downtime and allow the first job 34 to be completed. The CI system monitor 20 may determine that a second remote system 58 is available from a remote location that is external to the CI system 18 and the computing device 10, such as a remote repository of files or container images, an edge device, or a cloud computing device with resources for the tasks to use, as non-limiting examples. In some implementations, the first remote system 30 may be a service, and the CI system monitor 20 may access a service registry list 60 and identify an available service from the service registry list 60 that corresponds to the service (i.e., the first remote system 30). For instance, the CI system monitor 20 may identify the second remote system 58 as a service that is equivalent to the first remote system 30 service.

The CI system monitor 20 can modify the task 28 to use the second remote system 58 that is at the remote location, and the CI system monitor 20 can modify the first job 34 to use the second remote system 58. The CI system monitor 20 may send a request 62 to the second remote system 58 and the second remote system 58 may send a response 64 to the CI system monitor 20. The CI system monitor 20 may receive the response 64 from the second remote system 58, and determine that the second remote system 58 is available for use by the task 28 and the first job 34 based on the response 64. The CI system monitor 20 can continue to send requests to the first remote system 30 to determine whether the first remote system 30 has become available. The CI system monitor 20 may receive a response from the first remote system 30 indicating that the first remote system 30 is available and modify the task 28 to use the first remote system 30 and the CI system monitor 20 can modify the first job 34 to use the first remote system 30. After modifying the task 28 to use the first remote system 30 and modifying the first job 34 to use the first remote system 30, the CI system monitor 20 may execute the task 28 or the first job 34, wait for a period of time, and then execute the task 28 or the first job 34 which has not yet been executed. The order of executing the task 28 and the first job 34 after modifying the task 28 and the first job 34 to use the first remote system 30 may be based on a priority of the tasks 26, a priority of the jobs 24, the order of the tasks 26, or the order of the jobs 24, as non-limiting examples.

In another example, the CI system monitor 20 may perform the action 44 based on the priority 42 of the first job 34 by determining that the priority 42 of the first job 34 is a high priority and that a second remote system 66 is available from a local location of the CI system 18, such as on the computing device 10 or a component of the computing device 10. Because the priority 42 of the first job 34 is a high priority, the CI system monitor 20 can determine whether there is a local version of the first remote system 30 that is available at the local location of the CI system 18 in order to reduce downtime and allow the first job 34 to be completed. For instance, a local version or copy of the first remote system 30 may have been downloaded by another task onto the computing device 10 and is available for use (i.e., the second remote system 66), such as a remote service or a container image that was downloaded locally and can be used by other tasks and jobs. The CI system monitor 20 can modify the task 28 to use the second remote system 66 that is at the local location (e.g., a service that was previously downloaded to the computing device) and the CI system monitor 20 can modify the first job 34 to use the second remote system 66 that is at the local location.

In another example, the CI system monitor 20 may perform the action 44 based on the priority 42 of the first job 34 by determining that the priority 42 of the first job 34 is a high priority. The first remote system 30 may be a service and the CI system monitor 20 may access a manifest file 68 for the first remote system 30, the manifest file 68 corresponding to the service. The manifest file 68 may be a file with metadata that describes the service (i.e., the first remote system 30). The CI system monitor 20 may use the manifest file 68 to install the first remote system 30 as a local version or copy of the service. For instance, a local version or copy of the service (i.e., the first remote service 30) may be installed onto the computing device 10 and be available for use by other tasks and jobs. The CI system monitor 20 can modify the task 28 to use the local version of the service and the CI system monitor 20 can modify the first job 34 to use the local version of the service. Because the priority 42 of the first job 34 is a high priority, the CI system monitor 20 can install the local version of the service in order to reduce downtime and allow the first job 34 to be completed.

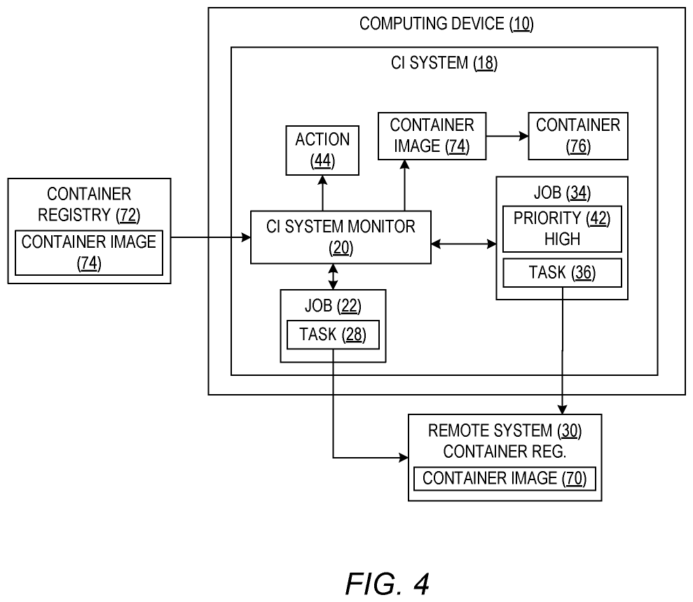

FIG. 4 is a block diagram of the computing device of FIG. 1 for continuous integration system monitoring for dependencies on remote systems, according to one example. Elements of FIG. 1 are referenced in describing FIG. 4 for the sake of clarity. In the example of FIG. 4, the CI system monitor 20 may perform the action 44 based on the priority 42 of the first job 34 by determining that the priority 42 of the first job 34 is high. The CI system monitor 20 may determine that the priority 42 of the first job 34 is a high priority by obtaining the file 40 that defines the first job 34 and parsing the file 40 to determine that the priority 42 of the first job 34 is a high priority. The first remote system 30 may be a remote container repository with a container image 70 for the task 28, the remote container repository being external to the CI system 18 and the computing device 10. Because the priority 42 of the first job 34 is a high priority, the CI system monitor 20 can determine whether there is another container repository with the container image for the task 28 that is external to the CI system 18 and the computing device 10 and that is available in order to reduce downtime and allow the first job 34 to be completed. The CI system monitor 20 may identify a container repository 72 at a remote location that is external to the CI system 18 and the computing device 10 and that has a container image 74 for the task 28 while the first remote system 30 is unavailable. The container image 74 and the container image 70 may be container images that can be used to initiate the same type of container. In some implementations, a container repository list may be accessible by the CI system monitor 20 and the CI system monitor 20 may identify the container repository 72 by accessing the container repository list and determining, based on the container repository list, that the container repository 72 is available and the container image 74 that can be used to initiate the same type of container as the container image 70. The CI system monitor 20 can pull the container image 74 from the container repository 72 and run a container 76 by initiating the container image 74.

The phrase “container” as used herein refers to Linux® containers wherein the Linux® kernel uses namespaces to isolate processes from one another. The phrase “container image” as used herein refers to a static package of software comprising one or more layers, the layers including everything needed to run an application (i.e., as a container) that corresponds to the container image, including, for example, one or more of executable runtime code, system tools, system libraries and configuration settings. A Docker® image is an example of a container image.

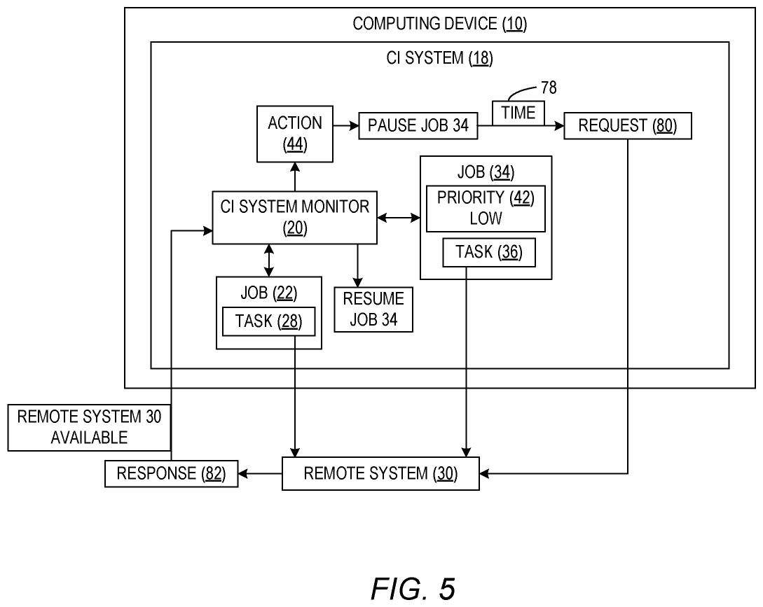

FIG. 5 is a block diagram of the computing device of FIG. 1 for continuous integration system monitoring for dependencies on remote systems, according to one example. Elements of FIG. 1 are referenced in describing FIG. 5 for the sake of clarity. In the example of FIG. 5, the CI system monitor 20 may perform the action 44 based on the priority 42 of the first job 34 by determining that the priority 42 of the first job 34 is low. The CI system monitor 20 may determine that the priority 42 of the first job 34 is a low priority by obtaining the file 40 that defines the first job 34 and parsing the file 40 to determine that the priority 42 of the first job 34 is a low priority. The CI system monitor 20 may pause the first job 34 for a predetermined amount of time 78 (e.g., 10-20 seconds) in order to stop the first job 34 and the tasks of the first job 34 (e.g., the task 36) from attempting to access the first remote system 30 that is unavailable. After waiting for the predetermined amount of time 78, the CI system monitor 20 may retry initiating the task 28 that invokes the first remote system 30 and/or the first job 34 with the at least one task 36 that invokes the first remote system 30. The CI system monitor 20 may send a request 80 to the first remote system 30 and receive a response 82 from the first remote system 30. When the response 82 indicates that the first remote system 30 is available, the CI system monitor 20 can resume the first job 34 with the at least one task 36 that invokes the first remote system 30 and the task 28 that invokes the first remote system 30.

The CI system monitor 20 may receive a response 82 from the first remote system 30 that indicates that the first remote system 30 is not available (e.g., an error code) or the CI system monitor 20 may receive no response from the first remote system 30 in response to the request 80. When there is no response or the response 82 indicates that the first remote system 30 is unavailable, the CI system monitor 20 may wait an additional predetermined period of time, which may be the same length or a different length of time from the predetermined amount of time 78. After waiting the additional predetermined period of time, the CI system monitor 20 may send a request (e.g., the request 80) to the first remote system 30 and receive a response (e.g., the response 82) from the first remote system 30. If the response indicates that the first remote system 30 is available, then the CI system monitor 20 can resume the first job 34 with the at least one task 36 that invokes the first remote system 30 and the task 28 that invokes the first remote system 30. If there is no response or the response indicates that the first remote system 30 is unavailable, the CI system monitor 20 may wait another predetermined amount of time, send a request to the first remote system 30, and receive a response from the remote system to determine whether the first remote system 30 is available. The CI system monitor 20 can continue sending a request to the first remote system 30, receiving a response, and waiting for a predetermined amount of time until the CI system monitor 20 receives a response indicating that the first remote system 30 is available. Upon a response indicating that the first remote system 30 is available, the CI system monitor 20 can resume the first job 34 with the at least one task 36 that invokes the first remote system 30 and the task 28 that invokes the first remote system 30.

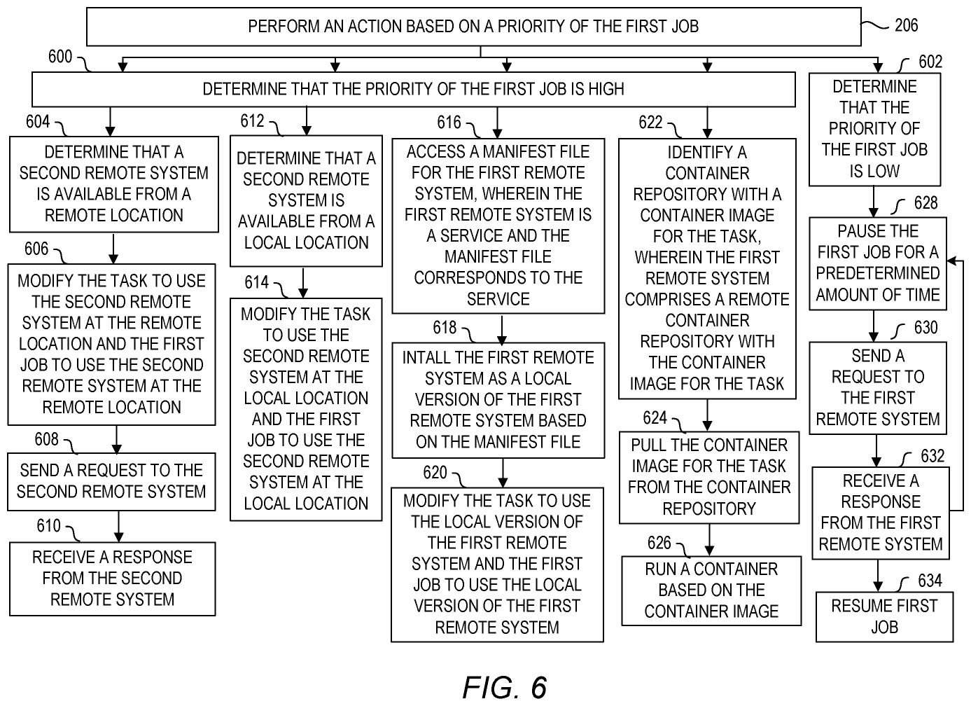

FIG. 6 is a flowchart illustrating operations performed by the computing device of FIG. 1 for continuous integration system monitoring for dependencies on remote systems, according to one example. Elements of FIG. 1 are referenced in describing FIG. 6 for the sake of clarity. In the example of FIG. 6, the CI system monitor 20 may perform an action based on a priority of the first job (block 206). The CI system monitor 20 may determine that the priority of the first job is high (block 600). Alternatively, the CI system monitor 20 may determine that the priority of the first job is low (block 602).

After determining that the priority of the first job is high (block 600), the CI system monitor 20 may determine that a second remote system is available from a remote location (block 604), modify the task to use the second remote system at the remote location and the first job to use the second remote system at the remote location (block 606), send a request to the second remote system (block 608), and receive a response from the second remote system (block 610). In another implementation, the CI system monitor 20 may determine that a second remote system is available from a local location (block 612) and modify the task to use the second remote system at the local location and the first job to use the second remote system at the local location (block 614). In another example, the CI system monitor 20 may access a manifest file for the first remote system, wherein the first remote system is a service and the manifest file corresponds to the service (block 616), install the first remote system as a local version of the first remote system based on the manifest file (block 618), and modify the task to use the local version of the first remote system and the first job to use the local version of the first remote system (block 620). In another implementation, the CI system monitor 20 may identify a container repository with a container image for the task, wherein the first remote system comprises a remote container repository with the container image for the task (block 622), pull the container image for the task from the container repository (block 624), and run a container based on the container image (block 626).

After determining that the priority of the first job is low (block 602), the CI system monitor 20 may pause the first job for a predetermined amount of time (block 628), send a request to the first remote system (block 630), and receive a response from the first remote system (block 632). The response from the first remote system may indicate that the first remote system is available, and the CI system monitor 20 may resume the first job in response (block 634). The response from the first remote system may indicate that the first remote system is not available, and the CI system monitor 20 may return to block 628 and repeat the steps of block 630 and block 632 until the response from the first remote system indicates that the first remote system is available and the CI system monitor can resume the first job in response (block 634).

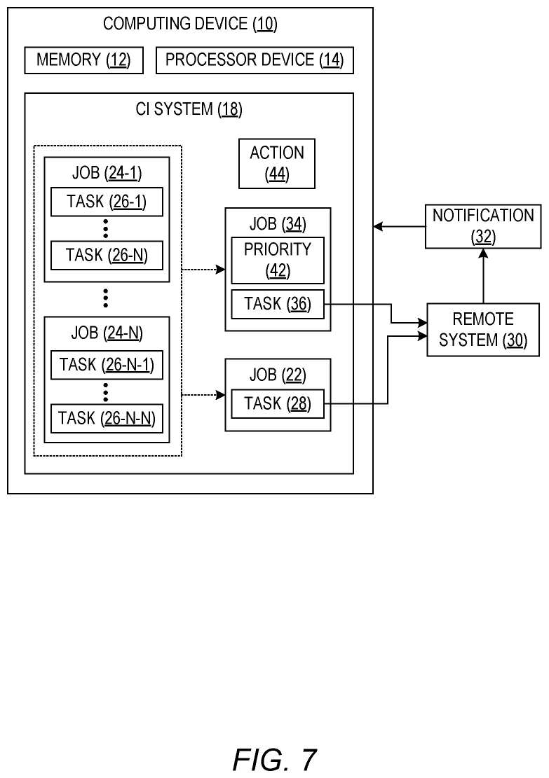

FIG. 7 is a block diagram of the computing device of FIG. 1 for continuous integration system monitoring for dependencies on remote systems, according to one example. Elements of FIG. 1 are referenced in describing FIG. 7 for the sake of clarity. In the example of FIG. 7, the computing device 10 includes the CI system 18, a system memory 12, and a processor device 14 coupled to the system memory 12. The processor device 14 is to execute a job 22 from among a plurality of jobs 24-1-24-N executed by a continuous integration system 18, the job 22 initiating a task 28 from among a plurality of tasks 26 for the job 22 and the task 28 invoking a first remote system 30. The processor device 14 is further to determine, based on a notification 32 associated with the first remote system 30, that the task 28 failed in response to invoking the first remote system 30. The processor device 14 is further to identify a first job 34 from among the plurality of jobs 24-1-24-N, the first job 34 having at least one task 36 that invokes the first remote system 30. The processor device 14 is further to perform an action 44 based on a priority 42 of the first job 34.

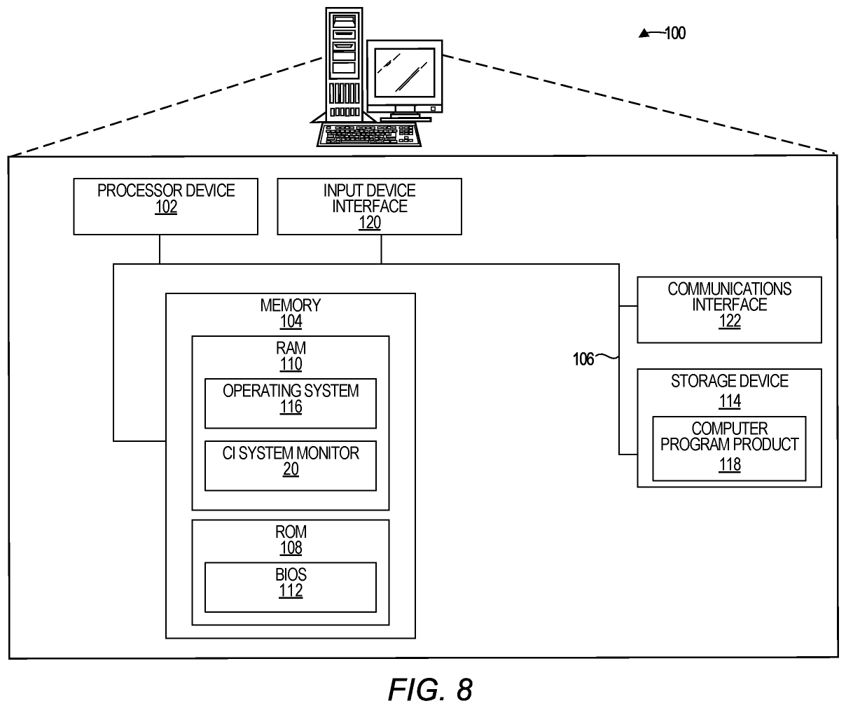

FIG. 8 is a block diagram of a computing device 100, such as the computing device 10 of FIG. 1, suitable for implementing examples according to one example. The computing device 100 may comprise any computing or electronic device capable of including firmware, hardware, and/or executing software instructions to implement the functionality described herein. The computing device 100 includes a processor device 102, such as the processor device 14, a system memory 104, such as the system memory 12, and a system bus 106. The system bus 106 provides an interface for system components including, but not limited to, the system memory 104 and the processor device 102. The processor device 102 can be any commercially available or proprietary processor.

The system bus 106 may be any of several types of bus structures that may further interconnect to a memory bus (with or without a memory controller), a peripheral bus, and/or a local bus using any of a variety of commercially available bus architectures. The system memory 104 may include non-volatile memory 108 (e.g., read-only memory (ROM), erasable programmable read-only memory (EPROM), electrically erasable programmable read-only memory (EEPROM), etc.), and volatile memory 110 (e.g., random-access memory (RAM)). A basic input/output system (BIOS) 112 may be stored in the non-volatile memory 108 and can include the basic routines that help to transfer information between elements within the computing device 100. The volatile memory 110 may also include a high-speed RAM, such as static RAM, for caching data.

The computing device 100 may further include or be coupled to a non-transitory computer-readable storage medium such as a storage device 114, such as the storage device 16, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 114 and other drives associated with computer-readable media and computer-usable media may provide non-volatile storage of data, data structures, computer-executable instructions, and the like.

A number of modules can be stored in the storage device 114 and in the volatile memory 110, including an operating system 116 and one or more program modules, such as the CI system monitor 20, which may implement the functionality described herein in whole or in part. All or a portion of the examples may be implemented as a computer program product 118 stored on a transitory or non-transitory computer-usable or computer-readable storage medium, such as the storage device 114, which includes complex programming instructions, such as complex computer-readable program code, to cause the processor device 102 to carry out the steps described herein. Thus, the computer-readable program code can comprise software instructions for implementing the functionality of the examples described herein when executed on the processor device 102. The processor device 102, in conjunction with the CI system monitor 20 in the volatile memory 110, may serve as a controller, or control system, for the computing device 100 that is to implement the functionality described herein.

An operator, such as a user, may also be able to enter one or more configuration commands through a keyboard (not illustrated), a pointing device such as a mouse (not illustrated), or a touch-sensitive surface such as a display device (not illustrated). Such input devices may be connected to the processor device 102 through an input device interface 120 that is coupled to the system bus 106 but can be connected by other interfaces such as a parallel port, an Institute of Electrical and Electronic Engineers (IEEE) 1394 serial port, a Universal Serial Bus (USB) port, an IR interface, and the like. The computing device 100 may also include a communications interface 122 suitable for communicating with the network as appropriate or desired. The computing device 100 may also include a video port (not illustrated) configured to interface with the display device (not illustrated), to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
executing, by a continuous integration (CI) system, a job from among a plurality of jobs executed by the CI system, the job initiating a task from among a plurality of tasks for the job and the task invoking a first remote system;
determining, by the CI system based on a notification associated with the first remote system, that the task failed in response to invoking the first remote system;
identifying, by the CI system, a first job from among the plurality of jobs, the first job having at least one task that invokes the first remote system; and
performing, by the CI system, an action based on a priority of the first job.

2. The method of claim 1, wherein determining, based on the notification associated with the first remote system, that the task failed in response to invoking the first remote system comprises:
receiving the notification from the first remote system.

3. The method of claim 1, wherein identifying the first job from among the plurality of jobs, the first job having at least one task that invokes the first remote system comprises:
obtaining a file that defines the first job; and
determining, based on the file, that the first job has the at least one task that invokes the first remote system.

4. The method of claim 1, further comprising:
subsequent to identifying the first job from among the plurality of jobs, pausing the first job.

5. The method of claim 1, wherein performing the action based on the priority of the first job comprises:
determining that the priority of the first job is high;
determining that a second remote system is available from a remote location;
modifying the task to use the second remote system at the remote location and the first job to use the second remote system at the remote location;
sending a request to the second remote system; and
receiving a response from the second remote system.

6. The method of claim 5, wherein the first remote system comprises a service, and wherein determining that the second remote system is available from the remote location comprises:
accessing a service registry list; and
identifying an available service from the service registry list that corresponds to the service, wherein the second remote system comprises the available service.

7. The method of claim 1, wherein performing the action based on the priority of the first job comprises:
determining that the priority of the first job is high;
determining that a second remote system is available from a local location; and
modifying the task to use the second remote system at the local location and the first job to use the second remote system at the local location.

8. The method of claim 1, wherein performing the action based on the priority of the first job comprises:
determining that the priority of the first job is low;
pausing the first job for a predetermined amount of time; and
sending a request to the first remote system.

9. The method of claim 8, further comprising:
in response to sending the request to the first remote system, receiving a response from the first remote system, the response indicating that the first remote system is available; and
resuming the first job.

10. The method of claim 1, wherein performing the action based on the priority of the first job comprises:
determining that the priority of the first job is high;
accessing a manifest file for the first remote system, wherein the first remote system is a service and the manifest file corresponds to the service;
installing the first remote system as a local version of the first remote system based on the manifest file; and
modifying the task to use the local version of the first remote system and the first job to use the local version of the first remote system.

11. The method of claim 1, wherein performing the action based on the priority of the first job comprises:
determining that the priority of the first job is high;
identifying a container repository with a container image for the task, wherein the first remote system comprises a remote container repository with the container image for the task;
pulling the container image for the task from the container repository; and
running a container based on the container image.

12. The method of claim 1, further comprising:
prior to performing the action based on the priority of the first job, obtaining a file that defines the first job; and
determining, based on the file, the priority of the first job.

13. The method of claim 1, further comprising:
prior to performing the action based on the priority of the first job, obtaining a file that defines the first job; and
determining, based on the file, a plurality of tasks of the first job and a priority of each task of the plurality of tasks, wherein the priority of the first job comprises a highest priority of each priority of the plurality of tasks.

14. The method of claim 1, further comprising:
subsequent to performing the action based on the priority of the first job, sending a request to the first remote system;
receiving a response from the first remote system, the response indicating that the first remote system is available; and
modifying the task to use the first remote system and the first job to use the first remote system.

15. The method of claim 14, wherein modifying the task to use the first remote system and the first job to use the first remote system comprises:
modifying the first job to use the first remote system;
executing the first job, the first job invoking the first remote system;
waiting a predetermined amount of time;
modifying the task to use the first remote system; and
executing the task, the task invoking the first remote system.

16. The method of claim 15, further comprising:
prior to modifying the first job to use the first remote system, determining that the at least one task of the first job is a final task of a plurality of tasks for the first job; and
determining that the task of the job is a first task of the plurality of tasks for the job.

17. The method of claim 1, further comprising:
obtaining a file that defines the job; and
determining, based on the file, that the task invokes the first remote system.

18. The method of claim 1, further comprising:
identifying a subset of jobs from among the plurality of jobs, each job of the subset of jobs having at least one task that invokes the first remote system; and
performing an action for each job of the subset of jobs based on a priority of each job of the subset of jobs.

19. A computing device, comprising:
a memory; and
a processor device coupled to the memory, the processor device to:
execute a job from among a plurality of jobs executed by a continuous integration system, the job initiating a task from among a plurality of tasks for the job and the task invoking a first remote system;
determine, based on a notification associated with the first remote system, that the task failed in response to invoking the first remote system;
identify a first job from among the plurality of jobs, the first job having at least one task that invokes the first remote system; and
perform an action based on a priority of the first job.

20. A non-transitory computer-readable storage medium that includes computer-executable instructions that, when executed, cause one or more processor devices to:
execute a job from among a plurality of jobs executed by a continuous integration system, the job initiating a task from among a plurality of tasks for the job and the task invoking a first remote system;
determine, based on a notification associated with the first remote system, that the task failed in response to invoking the first remote system;
identify a first job from among the plurality of jobs, the first job having at least one task that invokes the first remote system; and
perform an action based on a priority of the first job.
